(19) United States
(12) Patent Application Publication
(10) Pub. No.: US 2024/0367593 A1
(43) Pub. Date: Nov. 7, 2024

(54) VEHICLE FRONT MOUNTING SYSTEM AND ATMOSPHERIC SENSING ASSEMBLY

(71) Applicant: HEATH CONSULTANTS INCORPORATED, Houston, TX (US)

(72) Inventors: VINEET AGGARWAL, Richmond, TX (US); ALAN KENNETH STRATTON, Milford, NH (US); MARSHALL BRONFIN, Bedford, NH (US); KEVIN BENDELE, Seabrook, TX (US)

(73) Assignee: HEATH CONSULTANTS INCORPORATED, Houston, TX (US)

(21) Appl. No.: 18/652,443

(22) Filed: May 1, 2024

Related U.S. Application Data
(60) Provisional application No. 63/463,235, filed on May 1, 2023.

(51) Int. Cl. B60R 11/02; B60R 11/00; G01N 21/39

(52) U.S. Cl. CPC B60R 11/02; G01N 21/39; B60R 2011/004; B60R 2011/0066; B60R 2011/0071; G01N 2021/392

(57) ABSTRACT

A vehicle front mounting system adapted to mount to a vehicle brush guard or similar apparatus for supporting a device. The vehicle front mounting system including a pair of elongated tubular rails adapted to be attached to the vehicle brush guard, each tubular rail having a pair of elongated slots and a pair of elongated cavities. Each of the elongated slots opens to an elongated cavity. One or more threaded nuts are received and contained within each elongated cavity. The threaded nuts are permitted to slide within the elongated cavity while being restrained from rotating within the elongated cavity. One or more brackets are adapted to be to fastened to the pair of elongated rails.

### CROSS-REFERENCE TO RELATED APPLICATIONS

This application claims the benefit of U.S. Provisional Application Ser. No. 63/463,235, filed on May 1, 2023, entitled “Vehicle Front Mounting System and Atmospheric Sensing Assembly.” Applicant incorporates by reference herein Application Ser. No. 63/463,235 in its entirety.

### BACKGROUND OF THE INVENTION

### 1. Field of the Invention

The present invention relates generally to a mounting system for attachment to the front of a vehicle, and additionally to an atmospheric gas sensing assembly that may be releasably connected to the mounting system.

### 2. Description of the Related Art

Oftentimes there is a need or desire to temporarily mount or attach instrumentation, equipment, lighting, signage and the like, collectively referred to as devices, to the front of a vehicle. Preferably, the mounting of the device does not cause permanent damage or affect the aesthetic appearance of the vehicle upon removal of the device and/or mount.

In certain circumstances, it may be very important that the device is mounted securely to the vehicle to minimize movement of the device relative to the front of the vehicle. For example, the device mounted to the front of the vehicle may be a laser device, atmospheric instrumentation, lighting, etc. These devices may be mounted to various types of vehicles including, but not limited to, utility terrain vehicles or utility task vehicles (UTVs), all-terrain vehicles (ATVs), recreational utility vehicles (RUVs) and recreational off-highway vehicles (ROVs), to name a few.

It is desirable to have a mounting system adapted to mount to the front of the vehicles. It is further desirable to have a “universal” mounting system adapted to mount to various vehicles.

It is desired to have a vehicle front mounting system that is adjustable in the attachment to the vehicle and also adjustable with respect to the positioning and placement of the attached device.

It is also desired that the vehicle front mounting system be lightweight and easy to install and remove. Additionally, it is desirable to have a vehicle front mounting system that allows for the attached device to be temporarily removed without removal of the entire mount system.

### SUMMARY OF THE INVENTION

One embodiment of the present invention is a “universal” vehicle front mounting system for attaching to the front of numerous types of vehicles. In a preferred embodiment the front vehicle mounting system attaches to a tubular bumper, grille guard or brush guard of the vehicle.

According to an embodiment of the present invention the vehicle front mounting system is adapted to mount to a vehicle brush guard or similar apparatus for supporting a device and the mounting system includes a pair of tubular rails adapted to be attached to the vehicle brush guard with each tubular rail having an elongated slot opening to an elongated cavity. At least one nut, received and contained within each elongated cavity, is permitted to slide while being restrained from rotating within the elongated cavity, and one or more brackets are adapted to be to fastened to the pair of elongated rails.

### BRIEF DESCRIPTION OF THE SEVERAL VIEWS OF THE DRAWINGS

The invention is better understood by reading the detailed description of embodiments which follows and by examining the accompanying drawings, in which:

FIGS. 1 and 2 are perspective views of a preferred embodiment of the vehicle front mounting system attached to a vehicle, with a device connected to the mounting system;

FIG. 3 is a perspective view of the vehicle front mounting system and connected device shown in FIG. 1 attached to a brush guard of the vehicle;

FIG. 4 is a front view of the preferred embodiment of the vehicle front mounting system and connected device attached to the vehicle brush guard;

FIG. 5 is a side view of the preferred embodiment of the vehicle front mounting system and connected device attached to the vehicle brush guard;

FIG. 6 is a perspective view of an end portion of a mounting rail;

FIG. 6A is an end view of the mounting rail;

FIG. 7 is a perspective view of the vehicle front mounting system attached to a different vehicle brush guard, with a device connected to the mounting system;

FIG. 8 is a front view of the vehicle front mounting system and connected device attached to the vehicle brush guard of FIG. 7;

FIG. 9 is a side view of the vehicle front mounting system and connected device attached to the vehicle brush guard of FIG. 7;

FIG. 10 is a perspective view similar to FIG. 7 with the device removed from the vehicle front mounting system;

FIG. 11 is a perspective view showing the attachment of the vehicle front mounting system to the vehicle brush guard of FIG. 7;

FIG. 12 is a rear view showing the attachment of the vehicle front mounting system to the vehicle brush guard of FIG. 7;

FIG. 13 is a rear perspective view showing the attachment of the vehicle front mounting system to the vehicle brush guard of FIG. 7;

FIG. 14 is a front view of the device shown in FIGS. 1-5 and 7-9;

FIG. 15 is a perspective view of the device of FIG. 14; and

FIG. 16 is a partially exploded view of the device of FIG. 14.

### DESCRIPTION OF THE PREFERRED EMBODIMENTS

It should be understood at the outset that although illustrative implementations of one or more embodiments are described below, the disclosed assemblies, systems and methods may be implemented using any number of techniques, whether currently known or not yet in existence. The disclosure should in no way be limited to the illustrative implementations, drawings, and techniques described below, but may be modified within the scope of the appended claims along with their full scope of equivalents.

The following brief definition of terms shall apply throughout the application:
The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);
If the specification describes something as “exemplary” or an “example,” it should be understood that refers to a non-exclusive example;
The terms “about” or “approximately” or the like, when used with a number, may mean that specific number, or alternatively, a range in proximity to the specific number, as understood by persons of skill in the field of the art;
If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiment, or it may be excluded.

Embodiments of the invention will now be described with reference to the figures, in which like numerals reflect like elements throughout. The terminology used in the description presented herein is not intended to be interpreted in any restrictive or limited way, simply because it is being utilized in conjunction with the detailed description of certain specific embodiments of the invention. Furthermore, embodiments of the invention may include several novel features, no single one of which is solely responsible for its desirable attributes or which is essential to practicing the invention described herein.

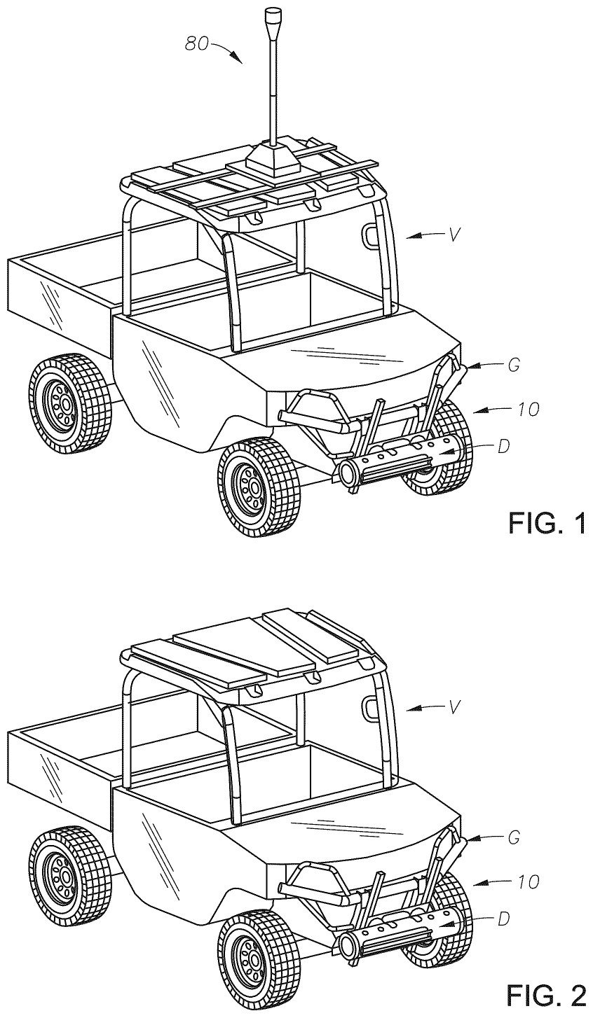

Referring to FIGS. 1 and 2, a preferred embodiment of a vehicle front mounting system 10 is shown attached to a vehicle V, preferably to a brush guard G of the vehicle V. It is to be understood that the vehicle V may be any of various types of vehicles. It is to be further understood that the vehicle front mounting system 10 is particularly adapted to mount to the front of the vehicle V, particularly a vehicle V of the type having a tubular bumper, grille guard or brush guard, generally referred to as a brush guard G. An instrument or device D is shown mounted to the front mounting system 10.

FIG. 1 additionally shows a rooftop assembly 80 as substantially disclosed in applicant's co-pending application Ser. No. 18/139,304 and published application US 2023/0340987. The rooftop assembly 80 is not a required feature of the present invention. In FIG. 2 the rooftop assembly 80 has been omitted.

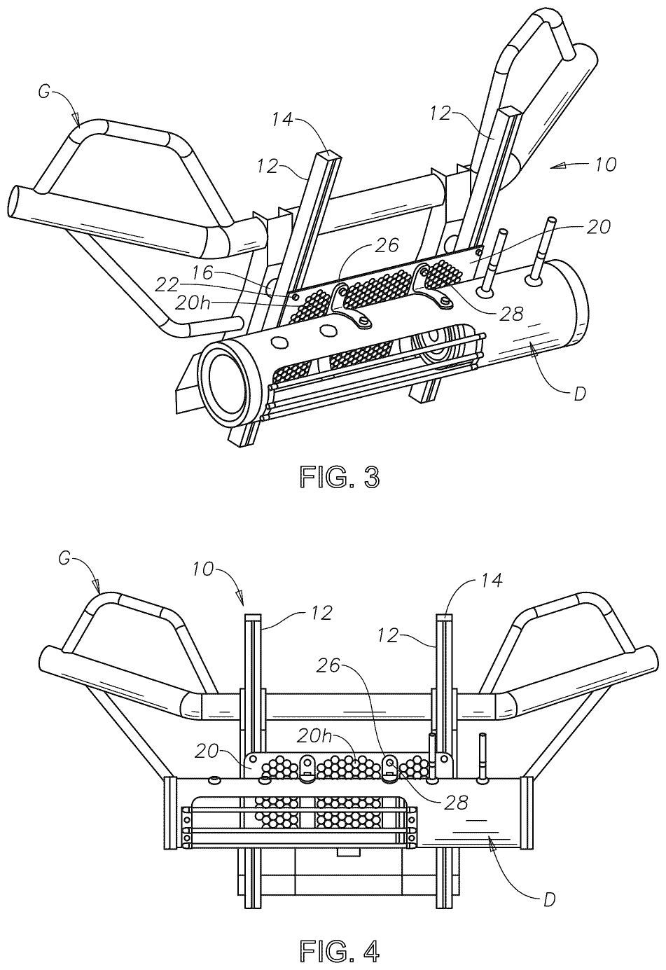

FIGS. 3-5 are views of the vehicle front mounting system 10 attached to the brush guard G with the instrument or device D connected to the mounting system 10. In a preferred embodiment, the mounting system 10 comprises a pair of elongated rails 12, preferably T-slotted rails. FIGS. 6 and 6A show a preferred embodiment of the T-slotted rail 12 having a pair of elongated slots 12s facing in opposite directions—one facing towards the front and one facing towards the rear. The rail 12 may be tubular and generally rectangular in cross-section. As shown in FIGS. 6 and 6A, the slots 12s open to a cavity 12c adapted to receive one or more threaded nuts 18 therein. The nuts 18 may be square or hexagonal in shape and are permitted to slide within the elongated cavity 12c of the elongated rail 12. Preferably, the nuts 18 are not allowed to rotate within the cavity 12c nor pass through the elongated slot 12s. It is to be understood that the nuts 18 may be placed into the cavity 12c from an end of the rail 12 and a cap 14 (FIG. 3) may be placed onto the rail end to prevent the nuts 18 from leaving the cavity 12c.

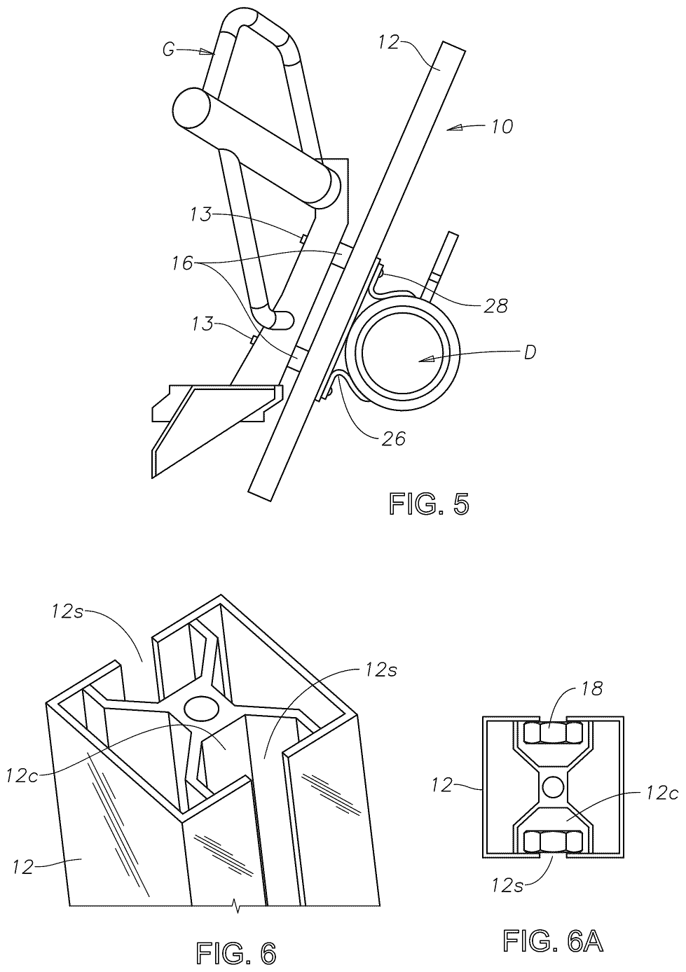

Referring to FIG. 5, the pair of rails 12 may be attached to the vehicle bumper or brush guard G using fasteners 13, preferably threaded fasteners, engaging the rails 12. In one preferred embodiment, a threaded fastener 13 is inserted through a hole in the brush guard G and optionally through a spacer 16 and through the rear rail slot 12s before threadedly engaging the nut 18 contained within the rear elongated cavity 12c. Each rail 12 may be secured to the brush guard G with one or more fasteners 13, preferably at least two. In one preferred embodiment, the pair of rails 12 are mounted to the brush guard G in a generally upright orientation. Preferably, the mounted rails 12 are parallel or substantially parallel to each other and perpendicular to the ground plane.

As best shown in FIGS. 3 and 4, an adapter plate 20 may be attached to the pair of rails 12 via screws, bolts or threaded fasteners 22 threadedly fastened to the nuts 18 in the front elongated cavity 12c. The adapter plate 20 has a plurality of holes and/or slots through which the screws 22 may pass prior to passing through the front slot 12s and engaging the nuts 18. It may be preferable to have longitudinal slots in the adapter plate 20 for the screws 22 to pass through so that the adapter plate 20 may be mounted to the rails 12 over a range of spacing between the rails 12. Upon tightening of the screws 22 and nuts 18, the adapter plate 20 is secured in place to the rails 12.

Referring to FIGS. 3-5, one or more brackets 26 may be fastened to the adapter plate 20, preferably via threaded fasteners 28. The brackets 26 may take a variety of forms, sizes and shapes. The brackets 26 may be used to mount the instrument and/or device D to the mounting system 10. The adapter plate 20 may have a plurality of holes 20h through which the fasteners may extend to mount the brackets 26 to the adapter plate 20. A large number of holes 20h provides flexibility and numerous attachment points for placing the brackets 26.

It is to be understood that the device D may be connected to the brackets 26 in numerous ways and may be dependent on the nature of the device D. The brackets 26 may be permanently attached to the device, for example by welding. Alternatively, threaded fasteners, straps, clamps, zip ties, hook and loop fasteners are just a few of other various types of fastening means that may be used to secure the device D to the brackets 26.

The mounting system 10 provides significant flexibility, adjustability, utility and positioning. The height of the rails 12 is adjustable over a range due to the rear slotted cavity 12c. The positioning of the rails 12 relative to the brush guard G may be varied via the use of the spacers 16. The height of the adapter plate 20 above the ground is adjustable over a range due to the front slotted cavity 12c. The plurality of holes and/or slots 20h in the adapter plate 20 provide versatility and flexibility in the attachment to the rails 12 and also the placement and positioning of the brackets 26.

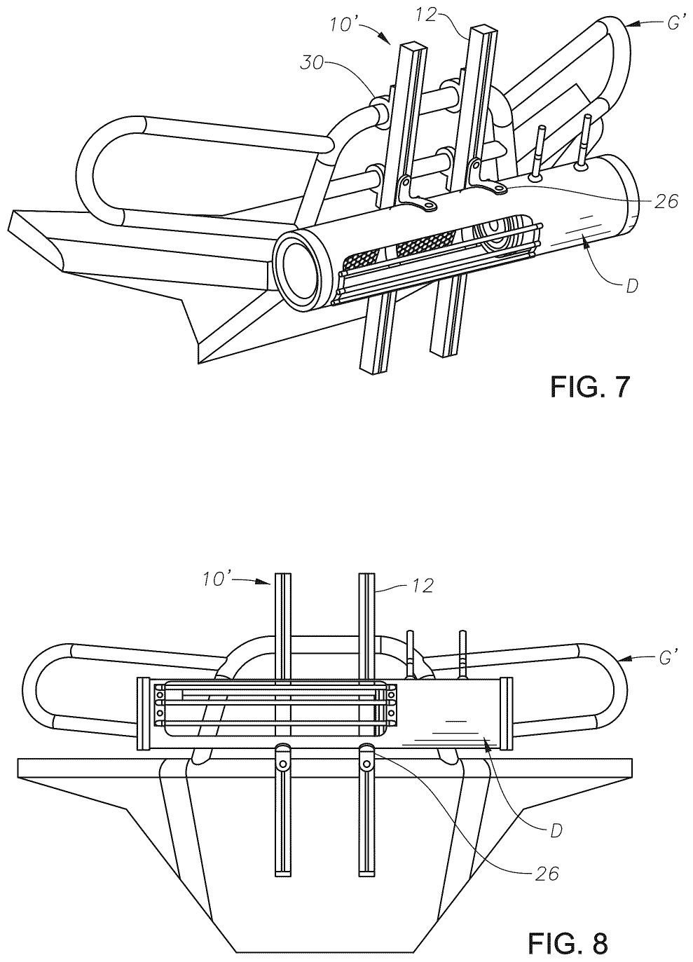

FIGS. 7-13 show another embodiment of the mounting system, generally referred to as 10′, attached to a different type of brush guard, generally referred to as G′. In the mounting system 10′, certain components may be the same or very similar to the components described above. For the same or similar components the same reference number will be used.

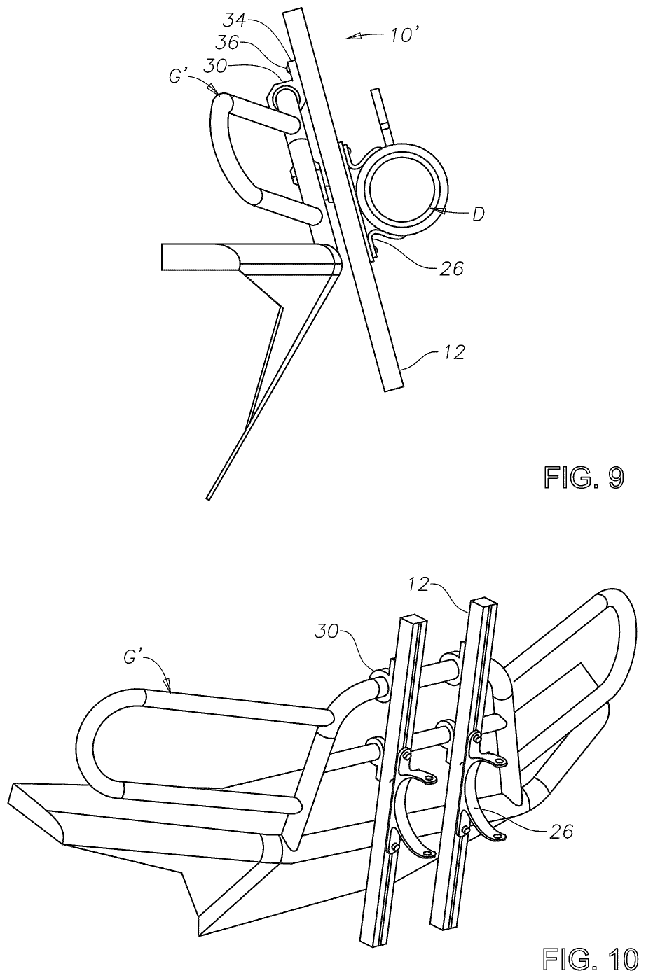

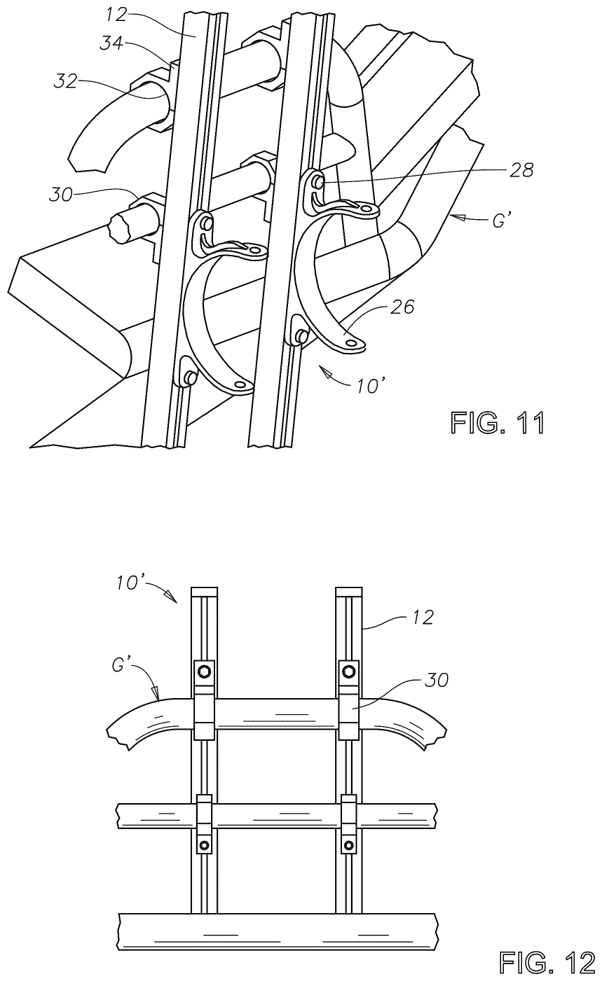

The mounting system 10′ comprises a pair of elongated rails 12 and brackets 26. Referring to FIGS. 7 and 9-13, one or more clamps 30 may be used to secure each rail 12 to the brush guard G′. The illustrated brush guard G′ comprises a plurality of round tubular members to which the clamps 30 may attach. Each clamp 30 may have a round opening 32 (FIG. 11) that can be placed around the guard tubular member and provide a snug or friction fit with the tubular member. The clamp 30 may comprise split or hinged clamp members for placement around the guard tubular member prior to joining the clamp members with a fastener. Additionally, the clamp 30 may include a flange 34 having a hole therethrough to receive a threaded fastener 36 (FIG. 9). The threaded fastener 36 is inserted through the flange hole and the rear elongated slot 12s and then threadedly engaged with the captured nut in the rear elongated cavity. Preferably, at least two clamps 30 are used to secure each rail 12 to the brush guard G′.

As shown in the figures, the brackets 26 may be attached directly to the rails 12 in the mounting system 10′. The bracket fasteners 28 (FIG. 11) are threaded onto the nuts 18 contained in the front elongated cavity 12c.

The mounting system 10′ provides similar flexibility, adjustability, utility and positioning as the mounting system 10. The height of the rails 12 is adjustable over a range due to the rear slotted cavity 12c. The horizontal spacing between the rails 12 is adjustable as a result of the clamps 30. The placement and positioning of the rails 12 in the horizontal direction is adjustable. The height of the brackets 26 is adjustable over a range due to the front slotted cavity 12c.

The vehicle front mounting system 10, 10′ is well suited for mounting instruments and devices for mobile surveillance, and particularly well suited for mounting instruments for mobile gas leak detection surveys. One such gas leak detection system is disclosed in applicant's co-pending Application Publication No. US 2023/0107797. Applicant incorporates by reference herein Publication No. US 2023/0107797 in its entirety.

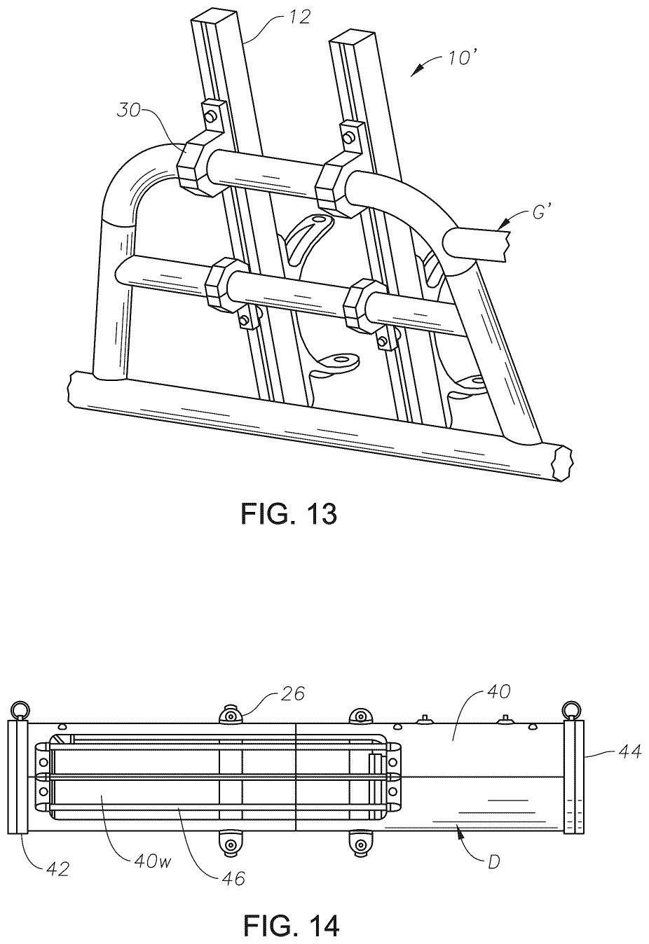

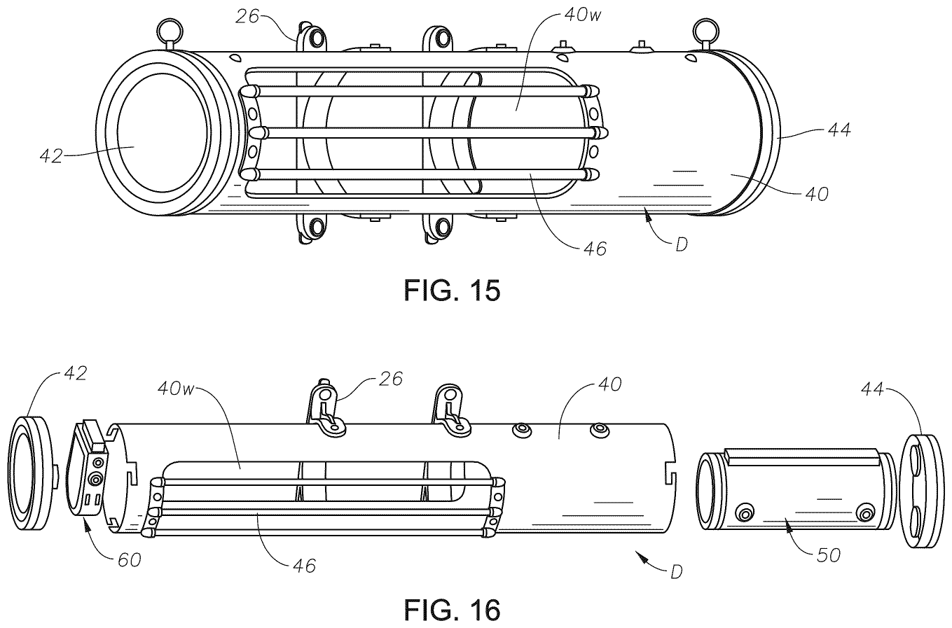

With reference to FIGS. 14-16, the device D preferably comprises a tube or tubular member 40 having removable first and second end caps 42 and 44. The end caps 42, 44 may be designed to be partially rotated for engagement and disengagement with the tube 40. The tube 40 preferably has a pair of large openings or open windows 40w along the length of the tube 40. The open windows 40w are preferably diametrically opposed to one another to allow air to freely flow into and out of the tube 40. One or more rod members 46 may span across at least the front open window 40w and be connected to the tube 40 to provide some protection against a foreign object from entering the tube 40 and damaging any instrumentation within the tube 40.

With reference to FIG. 16, mounted within the tube 40 is an electro-optic package 50 and a laser backscatter target package 60. The packages 50 and 60 may be securely mounted within the tube 40 with various types of fasteners, including threaded fasteners. Exemplary electro-optic and laser backscatter target packages, 50 and 60 respectively, are described in applicant's Publication No. US 2023/0107797. The laser backscatter target package 60 is spatially separated from and substantially aligned with one or more lasers of the electro-optic package 50. The orientation and alignment of the laser backscatter target package 60 relative to the electro-optic package 50 is maintained within the tube 40 to which they are mounted. Maintenance of the proper orientation and alignment is important in order to obtain the best signals and readings for the gas leak detection system. Additionally, the spacing between the laser backscatter target package 60 and the electro-optic package 50 is fixed by the mountings of the respective components within and to the tube 40.

The plurality of holes 20h in the adapter plate 20, when used, may reduce impeding the flow of air through the open windows 40w of the tube 40 between the electro-optic package 50 and the laser backscatter target package 60. The tube 40 may have a diameter of approximately seven inches (7″). The overall length of the tube 40 with the endcaps 42, 44 may be in the range of 30″ to 40″, and more preferably in the range of 34″ to 37″. In one embodiment, the overall length of the tube 40 with the endcaps 42, 44 is in the range of 35″ to 36″, and approximately 35.6″. The distance between the laser backscatter target package 60 and the electro-optic package 50 may be approximately 20″, approximately 50% of the distance disclosed in applicant's Publication No. US 2023/0107797. The sensitivity will be reduced by a factor of 2, but the accuracy is the same as it will be calibrated for the shorter light path.

The tube-installed gas leak detection system D greatly facilitates and simplifies the installation of the gas leak detection system onto a survey vehicle V. This also facilitates the removal of the gas leak detection system D and quick re-installation of the system. The tube 40 with the gas leak detection system may be easily removed from the brackets 26 or the brackets 26 with the tube 40 and gas leak detection system may be easily removed from the adapter plate 20 or the rails 12.

### NOMENCLATURE

device D
brush guard G, G′
vehicle V
vehicle front mounting system 10, 10′
elongated rail 12
cavity 12c
elongated slot 12s
fasteners 13
cap 14
spacer 16
nut 18
adapter plate 20
holes 20h
screws 22
bracket 26
fasteners 28
clamps 30
opening 32
flange 34
fastener 36
tube 40
open window 40w
first end cap 42
second end cap 44
rod member 46
electro-optic package 50
laser backscatter target package 60
rooftop assembly 80

While the invention has been described in detail above with reference to specific embodiments, it will be understood that modifications and alterations in the embodiments disclosed may be made by those practiced in the art without departing from the spirit and scope of the invention. All such modifications and alterations are intended to be covered. In addition, all publications cited herein are indicative of the level of skill in the art and are hereby incorporated by reference in their entirety as if each had been individually incorporated by reference and fully set forth.

What is claimed is:

1. A vehicle front mounting system adapted to mount to a vehicle brush guard or similar apparatus for supporting a device, the vehicle front mounting system comprising:
a pair of elongated tubular rails adapted to be attached to the vehicle brush guard, each tubular rail having a pair of elongated slots and a pair of elongated cavities, each elongated slot opening to an elongated cavity;
one or more threaded nuts received and contained within each elongated cavity, the threaded nuts are permitted to slide within the elongated cavity while being restrained from rotating within the elongated cavity; and
one or more brackets adapted to be to fastened to the pair of elongated rails.

2. The vehicle front mounting system of claim 1, wherein the pair of elongated slots face in opposite directions, one elongated slot facing towards the front and one elongated slot facing towards the rear.

3. The vehicle front mounting system of claim 2, further comprising:
a pair of clamps adapted to be connected to each tubular rail, each clamp having an opening for placement around a tubular member of the brush guard or similar apparatus and providing a friction fit with the tubular member.

4. The vehicle front mounting system of claim 3, further comprising:
a threaded fastener for each clamp, the threaded fastener extending through a hole in a flange of the clamp and through the elongated slot and engaging a nut contained within the rear-facing elongated slot.

5. The vehicle front mounting system of claim 3, wherein the one or more brackets comprises a first bracket attached to one tubular rail via at least one threaded fastener threadedly engaging the nut in the forward-facing elongated cavity of the one tubular rail and a second bracket attached to the other tubular rail via at least one threaded fastener threadedly engaging the nut in the forward-facing elongated cavity of the other tubular rail.

6. The vehicle front mounting system of claim 2, further comprising:
an adapter plate having a plurality of holes; and
a plurality of fasteners for attaching the adapter plate to the pair of tubular rails,
wherein the one or more brackets are fastened to the adapter plate.

7. The vehicle front mounting system of claim 1, wherein the device comprises:
a tube having at least one large opening in a side of the tube;
first and second end caps removably engaging first and second ends of the tube; and
one or more rod members connected to the tube and spanning across the at least one large opening,
wherein the one or more brackets are fastened to the tube.

8. The vehicle front mounting system of claim 7, wherein the at least one large opening comprises a front opening and a rear opening diametrically opposed to the front opening to allow air to freely flow into and out of the tube.

9. The vehicle front mounting system of claim 8, wherein the device further comprises:
an electro-optic package mounted within the tube adjacent the first end of the tube; and
a laser backscatter target package mounted within the tube adjacent the second end of the tube.

10. The vehicle front mounting system of claim 9, wherein the front and rear openings are located between the mounted electro-optic package and the laser backscatter target package.

11. A vehicle front mounting system for supporting a device, the front mounting system adapted to mount to a vehicle brush guard or similar apparatus, the front mounting system comprising:
at least one elongated rail having a front elongated slot opening to a front elongated cavity and a rear elongated slot opening to a rear elongated cavity;
at least one threaded nut received and contained within each elongated cavity, the threaded nuts being permitted to slide within the elongated cavities while being restrained from rotating within the elongated cavity; and
at least one bracket adapted to be to fastened to the at least one elongated rail.

12. The vehicle front mounting system of claim 11, wherein the device comprises an atmospheric sensing assembly comprising:
a tube having first and second ends and having first and second open windows facing in opposite directions;
an electro-optic package mounted inside the tube at a first end of the tube; and
a laser backscatter target package mounted inside the tube at a second end of the tube.
